(19) United States
(12) Patent Application Publication
(10) Pub. No.: US 2014/0127362 A1
(43) Pub. Date: May 8, 2014

(54) COMBINATION FOODSTUFF CONTAINER AND AERIAL TOY

(71) Applicant: AEROPAC, LLC, Greenwich, CT (US)

(72) Inventor: Lee H. MILLER, Greenwich, CT (US)

(73) Assignee: AEROPAC, LLC, Greenwich, CT (US)

(21) Appl. No.: 13/828,814

(22) Filed: Mar. 14, 2013

Related U.S. Application Data
(60) Provisional application No. 61/723,002, filed on Nov. 6, 2012.

(51) Int. Cl. A23G 9/50; B65B 1/00; A63H 27/00

(52) U.S. Cl. CPC A23G 9/503; A63H 27/00; B65B 1/00
USPC 426/104; 53/473

(57) ABSTRACT

A foodstuff containment and toy apparatus includes a hollow tube having a first opening at a first axial end of the tube, a second opening at a second axial end of the tube, and a length defined between the first and second axial ends. The first and second openings access an interior lumen of the tube. A first removable cover spans the first opening. A second removable cover spans the second opening. A foodstuff is disposed within the interior lumen of the tube and between the first and second removable covers. The tube includes a weighted portion proximate the first axial end such that a center of mass of the tube, without the first and second removable covers and the foodstuff, is located approximately within one-third of the length of the tube nearest the first opening.

### CROSS-REFERENCE TO RELATED APPLICATIONS

This application claims priority U.S. Provisional Patent Application No. 61/732,002, filed on Nov. 6, 2012, entitled “Combination Foodstuff Container and Aerial Toy,” the entire contents of which are incorporated by reference herein.

### BACKGROUND OF THE INVENTION

Embodiments of the present invention relate generally to a combination foodstuff container and toy, and more particularly, to a container for ice cream or other frozen confectionary that can be used as an aerial toy upon consumption of the contents of the container.

It is known to package a toy with a foodstuff in a container. However, it is uncommon that the packaging for the foodstuff is itself a toy dedicated toy that may be utilized following consumption of the foodstuff.

It is desirable to provide a foodstuff container that not only holds the foodstuff, but can be used as a toy once the foodstuff has been consumed. This allows the maximum amount of foodstuff to fill the container, and saves on time and money in packaging a toy with the foodstuff.

### BRIEF SUMMARY OF THE INVENTION

Briefly stated, an embodiment of the present invention comprises a foodstuff containment and toy apparatus including a hollow tube having a first opening at a first axial end of the tube, a second opening at a second axial end of the tube, and a length defined between the first and second axial ends. The first and second openings access an interior lumen of the tube. A first removable cover spans the first opening. A second removable cover spans the second opening. A foodstuff is disposed within the interior lumen of the tube and between the first and second removable covers. The tube includes a weighted portion proximate the first axial end such that a center of mass of the tube, without the first and second removable covers and the foodstuff, is located approximately within one-third of the length of the tube nearest the first opening.

Another embodiment of the present invention comprises a method of preparing a foodstuff containment and toy apparatus. The method includes at least partially filling a hollow tube with a foodstuff. The hollow tube has a first opening at a first axial end of the tube, a second opening at a second axial end of the tube, and a length defined between the first and second axial ends. The first and second openings access an interior lumen of the tube. The tube includes a weighted portion proximate the first axial end such that a center of mass of the tube is located approximately within one-third of the length of the tube nearest the first opening. The method further includes placing a first removable cover on the tube to span the first opening and placing a second removable cover on the tube to span the second opening.

### BRIEF DESCRIPTION OF THE DRAWINGS

The foregoing summary, as well as the following detailed description of preferred embodiments of the invention, will be better understood when read in conjunction with the appended drawings. For the purpose of illustration, there are shown in the drawings embodiments which are presently preferred. It should be understood, however, that the invention is not limited to the precise arrangements and instrumentalities shown.

FIG. 1 is a top plan view of tube for use with a first preferred embodiment of the present invention;

FIG. 2 is a side elevational view of the tube of FIG. 1;

FIG. 3 is a side elevational cross-sectional view of a foodstuff containment and toy apparatus in accordance with a first preferred embodiment of the present invention;

FIG. 4 is a greatly enlarged partial side elevational cross-sectional view of a tube for use with a second preferred embodiment of the present invention;

FIG. 5 is an enlarged partial side elevational cross-sectional view of a tube for use with a third preferred embodiment of the present invention;

FIG. 6 is a side elevational cross-sectional view of a tube for use with a fourth preferred embodiment of the present invention;

FIG. 7 is a side elevational cross-sectional view of a foodstuff containment and toy apparatus in accordance with a fifth preferred embodiment of the present invention; and

FIG. 8 is a top plan view of a foodstuff containment and toy apparatus in accordance with a sixth preferred embodiment of the present invention.

### DETAILED DESCRIPTION OF THE INVENTION

Certain terminology is used in the following description for convenience only and is not limiting. The words “right”, “left”, “lower”, and “upper” designate directions in the drawings to which reference is made. The words “inwardly” and “outwardly” refer to directions toward and away from, respectively, the geometric center of the device and designated parts thereof. The terminology includes the above-listed words, derivatives thereof, and words of similar import. Additionally, the words “a” and “an”, as used in the claims and in the corresponding portions of the specification, mean “at least one.”

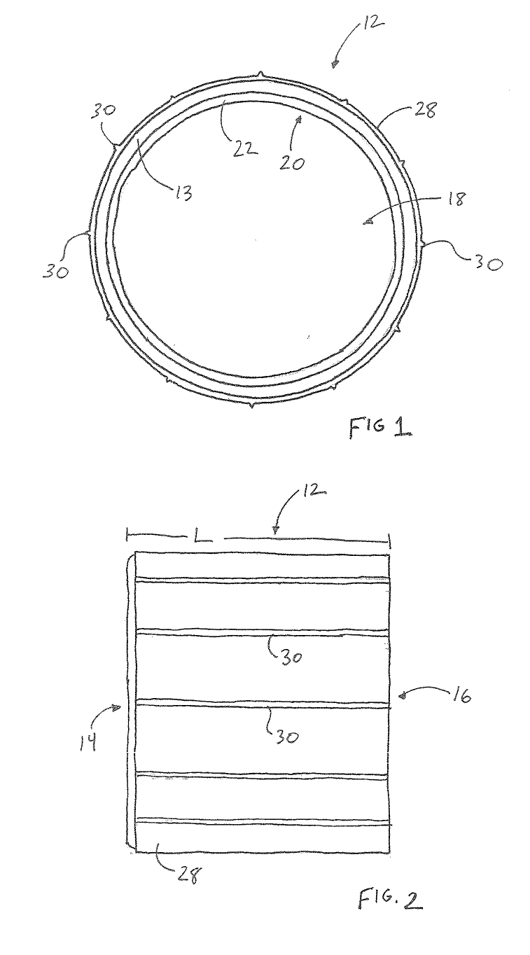

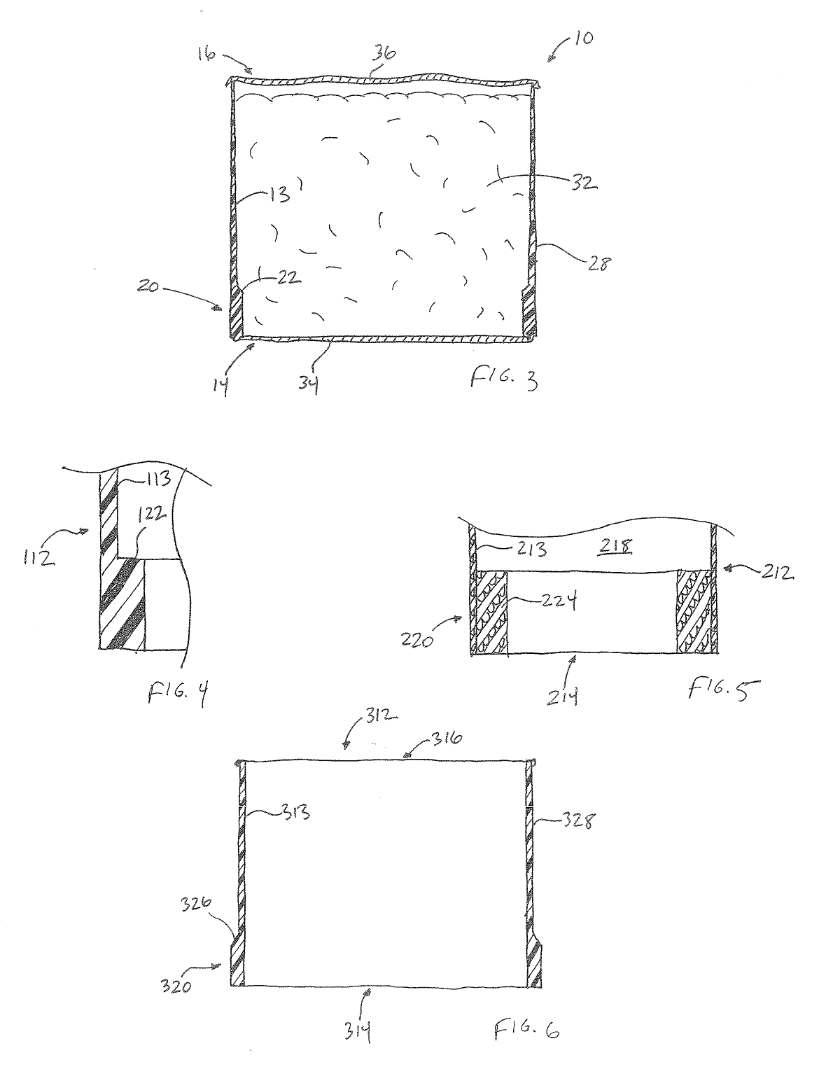

Referring to the drawings in detail, wherein like reference numerals indicate like elements throughout, there is shown in FIGS. 1-3 a first preferred embodiment of a foodstuff containment and toy apparatus 10. The apparatus 10 includes a hollow tube 12 having a first opening 14 at a first axial end thereof and a second opening 16 at a second axial end thereof. The first and second axial ends define a length L of the tube 12. The first and second openings 14, 16 access an interior lumen 18 of the tube 12 defined by an inner surface 13. The tube 12 may be made from rolled paperboard, a molded polymeric material, or any other type of durable, food-safe material.

The hollow tube 12 is the portion of the apparatus 10 which serves as the toy. In particular, the hollow tube 12 is designed as an aerial toy which may be thrown by and/or between participants. To enhance the aerial performance of the tube 12, a weighted portion 20 is provided proximate the first axial end of the tube 12. It is preferred that a center of mass of the tube 12 is located approximately within the one-third of the length L of the tube 12 nearest the first opening 14. This configuration allows for longer and stabler flight of the tube 12 when thrown.

The weighted portion 20 of the tube 12 can be formed in a number of ways. In the first preferred embodiment, the weighted portion 20 is formed by a thickening of the wall of the tube 12 proximate the first opening 14. As seen in FIGS. 1 and 3, a radially inwardly projecting ledge 22, integrally formed by the material of the tube 12, is disposed in the interior lumen 18 and extends around a perimeter of the inner surface 13 of the tube 12. As a result, a diameter of the second opening 16 is larger than a diameter of the first opening 14. In this manner, an outer surface 11 of the tube 12 maintains a generally constant diameter along the length L of the tube 12. In the first preferred embodiment, the ledge 22 is tapered relative to the inner surface 13 of the tube 12. However, in a second preferred embodiment (FIG. 4), the ledge 122 is formed generally perpendicularly to the inner surface 113 of the tube 112, and does not include a taper. While the drawings show the weighted portion 20 extending all the way to the first opening 14, the weighted portion can be formed entirely intermediate of the first and second openings 14, 16 such that the diameters of the first and second openings 14, 16 are generally identical.

In addition to the weighted portion 20, the inner surface 13 of the tube 12 may be tapered radially inwardly along at least a portion of the length L of the tube 12. As can be seen from FIG. 3, it is preferred that the taper extend along the inner surface 13 from the second opening 16 to the weighted portion 20. This configuration aids in moving the center of mass of the tube 12 closer to the first opening 14. The taper of the inner surface 13 is preferably no more than half of a degree. However, tapers larger than half of a degree may be used as desired.

In a third preferred embodiment (FIG. 5), the weighted portion 220 of the tube 212 may be accomplished by securing a ring 224 to the inner surface 213 of the tube 212 proximate the first opening 214. The ring 224 has a generally annular shape and is preferably made from rolled paperboard, molded polymeric material, or another durable food-safe material. The ring 224 is also preferably made from the same material as the tube 212, but the materials may also be different from each other. The ring 224 may be secured to the inner surface 213 of the tube 212 using a food-safe adhesive. However, the ring 224 may also be friction-fit into the interior lumen 218, welded to the inner surface 213, or the like.

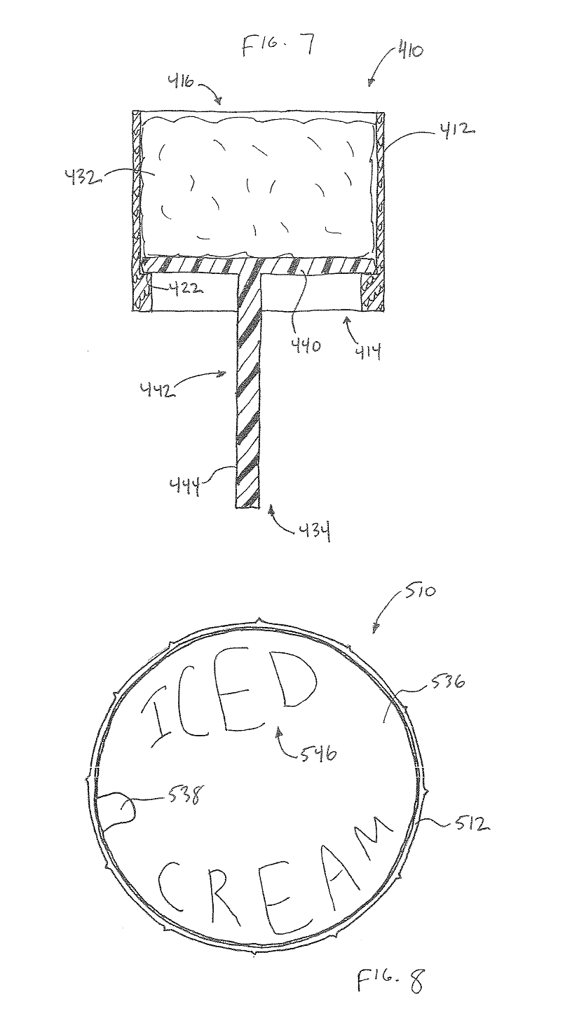

In a fourth preferred embodiment (FIG. 6), the weighted portion 320 is again formed by a thickening of the wall of the tube 312 proximate the first opening 314. In contrast to the embodiment of FIGS. 1-3, the diameters of the first and second openings 314, 316 are generally identical and the inner surface 313 of the tube 312 maintains a generally constant diameter. Instead, the weighted portion 320 includes a radially outwardly projecting ledge 326 integrally formed by the material of the tube 312. As a result, an outer perimeter of the tube 312 proximate the first axial end and first opening 314 is smaller than an outer perimeter of the tube 312 proximate the second axial end and second opening 316. The outwardly projecting ledge 326 may taper or be formed generally perpendicularly to an outer surface 328 of the tube 312, as before. In addition, the weighted portion 320 could be formed as a ring (not shown) secured to the outer surface 328 of the tube 312.

Returning to FIGS. 1-3, the tube 12 may also include a plurality of ribs 30 disposed on the outer surface 28. Each of the ribs 30 preferably extends at least partially along the length L of the tube 12. The ribs 30 are preferably integrally formed with the tube 12 as raised portions of the outer surface 28 thereof However, the ribs 30 may also be adhered or otherwise fastened to the tube 12. The ribs 30 help reduce wobble of the tube 12 in flight and allow the user to better grip the tube 12 for catching and/or throwing. Although the ribs 30 are shown as extending along a longitudinal axis of the tube 12, other patterns, such as diagonal, helical, or the like, may be used. In addition, referring to the embodiment in FIG. 6, the tube 312 may also include a lip 348 at one or both of the first and second axial ends extending around a perimeter of the respective first and second openings 314, 316.

The apparatus further includes a first removable cover 34 that spans the first opening 14 of the tube 12 and a second removable cover 36 that spans the second opening 16 of the tube 12. The first and second removable covers 34, 36 serve to retain a foodstuff 32 within the interior lumen 18 of the tube 12. The first and second removable covers 34, 36 may be made from metal foil, polymeric material, paper, or the like. While the first and second removable covers 34, 36 may be made from the same material, it is contemplated that the first removable cover 34 will typically serve as the bottom of the apparatus 10. As a result, the first removable cover 34 will bear the brunt of the weight of the foodstuff 32 and will therefore be required to be sturdier than the second removable cover 36.

The first and/or second removable covers 34, 36 may be attached to the tube 12 at the respective axial ends thereof, or may be recessed into the tube 12. The first and second removable covers 34, 36 may be placed using vacuum sealing, heat sealing, food-safe adhesives, press-fitting, snap-fitting, or the like. While only one of the removable covers 34, 36 is required to be removed for consumption of the foodstuff 32, both of the covers 34, 36 should be easily removable to allow the tube 12 to be used as the toy following consumption of the foodstuff 32. As can be seen in the embodiment shown in FIG. 8, the second removable cover 536 may include a pull tab 538 for ease of removal of the second removable cover 536 from the tube 512. The second removable cover 536 may also include one or more graphical designs 546, such as logos, nutritional or other information, art, advertising, or the like. The first removable cover (not shown in FIG. 8) may also include a pull tab 538 or graphical design 546.

In one embodiment, shown in FIG. 7, the first removable cover 434 is in the form of a plunger 440 disposed within the interior lumen 418 of the tube 412 and is axially movable therein. A piston 442 having a gripping portion 444 is attached to the plunger 440 to allow a user to move the plunger 440 to expel the foodstuff 432 through the second opening 416 to be consumed. The plunger 440 preferably has a diameter greater than the diameter of the first opening 414 so that the plunger 440 cannot be withdrawn through the first opening 414. Where the tube 412 includes the radially inwardly projecting ledge 422, it is preferred that the plunger initially abut the inwardly projecting ledge 422 to prevent withdrawal through the first opening 414.

The tube 12 is preferably sized to accommodate a single serving of the foodstuff 32, which is preferably in the form of ice cream, yogurt, sherbet, gelatin, custard, water ice, sorbet, pudding, gelato, or the like. However, the foodstuff 32 can also be of any other type of ready-made foodstuff, including cereals, crackers, chips, granolas, candies, nuts, seeds, popcorn, fruits, or the like. In some embodiments, the apparatus 10 may be used as a cook-in microwavable container for foodstuffs 32 such as pastas, soups, rice, stews, or the like. The apparatus 10 can also be used to contain beverages.

Methods of preparing the apparatus 10 will now be described. The tube 12 is first provided and any food-safe coating necessary is applied to at least a portion of the inner surface 13 thereof. The first removable cover 34 is then placed on the tube 12 to span the first opening 14. The tube 12 is then at least partially filled with the foodstuff 32. Typically a void will be left between the second opening 16 and the foodstuff 32 to allow for thermal expansion of the foodstuff 32 without rupturing the apparatus 10. Following the filling of the tube 12, the second removable cover 36 is placed on the tube 12 to span the second opening 16, thus sealing the foodstuff 32 within the tube 12.

Although the first removable cover 34 is described as being placed on the tube 12 prior to filling with the foodstuff 32, in some instances it may be possible to apply both the first and second removable covers 34, 36 after the filling of the tube 12. In addition, the step of coating the inner surface 13 of the tube 12 with a food-safe material can be performed after application of the first removable cover 34.

In embodiments such as that of FIG. 7, the first removable cover 436 is a plunger 440 and the step of placing the first removable cover 436 includes disposing the plunger 440 within the interior lumen 418 of the tube 412. The plunger 440 is preferably inserted through the second opening 416 and may come to rest on the inwardly projecting ledge 422. The piston 442 may be attached to the plunger 440 prior to or subsequent to the insertion of the plunger 440 into the tube 412.

Although various preferred embodiments of the present invention have been shown and described above, the invention is not so limited. Features of the various preferred embodiments described above may be used in place of, or in combination with, other features of the other embodiments described above without departing from the invention.

It will be appreciated by those skilled in the art that changes could be made to the embodiments described above without departing from the broad inventive concepts thereof. It is understood, therefore, that this invention is not limited to the particular embodiments disclosed, but it is intended to cover modifications within the spirit and scope of the present invention as defined by the appended claims.

We claim:

1. A foodstuff containment and toy apparatus comprising:
a hollow tube having a first opening at a first axial end of the tube, a second opening at a second axial end of the tube, and a length defined between the first and second axial ends, the first and second openings accessing an interior lumen of the tube;
a first removable cover spanning the first opening;
a second removable cover spanning the second opening; and
a foodstuff disposed within the interior lumen of the tube and between the first and second removable covers,
the tube including a weighted portion proximate the first axial end such that a center of mass of the tube, without the first and second removable covers and the foodstuff, is located approximately within one-third of the length of the tube nearest the first opening.

2. The apparatus of claim 1, wherein the first opening has a first diameter and the second opening has a second diameter larger than the first diameter.

3. The apparatus of claim 2, wherein the weighted portion of the tube includes a radially inwardly projecting ledge disposed in the interior lumen of the tube and extending around a perimeter of an inner surface of the tube.

4. The apparatus of claim 3, wherein the ledge is tapered relative to the inner surface of the tube.

5. The apparatus of claim 2, wherein an inner surface of the tube extending from the second opening tapers radially inwardly along at least a portion of the length of the tube.

6. The apparatus of claim 2, wherein the weighted portion includes a ring secured to an inner surface of the tube proximate the first opening of the tube.

7. The apparatus of claim 1, wherein the first removable cover is a plunger disposed within the interior lumen of the tube and is axially movable with respect to the tube.

8. The apparatus of claim 7, wherein a piston is attached to the plunger and includes a gripping portion.

9. The apparatus of claim 1, wherein the tube has a first outer perimeter proximate the first axial end and a second outer perimeter proximate the second axial end, the second outer perimeter being smaller than the first outer perimeter.

10. The apparatus of claim 1, wherein a plurality of ribs are disposed on an outer surface of the tube, each extending at least partially along the length of the tube.

11. The apparatus of claim 1, wherein the second axial end of the tube includes a lip extending around a perimeter of the second opening.

12. The apparatus of claim 1, wherein at least one of the first and second removable covers is made from one of a metal foil, a polymeric material, or a paper.

13. The apparatus of claim 1, wherein at least one of the first and second removable covers includes a pull tab.

14. The apparatus of claim 1, wherein the tube is made from one of a polymeric material or a paper.

15. The apparatus of claim 1, wherein the foodstuff is one of ice cream, yogurt, sherbet, gelatin, custard, water ice, sorbet, pudding, or gelato.

16. A method of preparing a foodstuff containment and toy apparatus, the method comprising:
at least partially filling a hollow tube with a foodstuff, the hollow tube having a first opening at a first axial end of the tube, a second opening at a second axial end of the tube, and a length defined between the first and second axial ends, the first and second openings accessing an interior lumen of the tube, the tube including a weighted portion proximate the first axial end such that a center of mass of the tube is located approximately within one-third of the length of the tube nearest the first opening;
placing a first removable cover on the tube to span the first opening; and
placing a second removable cover on the tube to span the second opening.

17. The method of claim 16, wherein the first removable cover is a plunger, and the step of placing the first removable cover includes disposing the plunger within the interior lumen of the tube.

18. The method of claim 17, further comprising attaching a piston to the plunger.

19. The method of claim 16, wherein the first removable cover is placed before the step of at least partially filling the tube.

20. The method of claim 16, wherein prior to the step of at least partially filling the tube, at least a portion of an inner surface of the tube is coated with a food-safe material.
